(19) United States
(12) Patent Application Publication
(10) Pub. No.: US 2008/0227520 A1
(43) Pub. Date: Sep. 18, 2008

(54) GAMING MACHINE CHECKING COLOR OF SYMBOL ON REEL

(75) Inventors: Hidekazu KATO, Zama city (JP); Toshiaki SHIMIZU, Zama city (JP)

Correspondence Address: GLOBAL IP COUNSELORS, LLP, 1233 20TH STREET, NW, SUITE 700, WASHINGTON, DC, 20036-2680, US

(73) Assignee: KONAMI GAMING INCORPORATED, Las Vegas, NV (US)

(21) Appl. No.: 11/686,916

(22) Filed: Mar. 15, 2007

(51) Int. Cl. G07F 9/02

(52) U.S. Cl. 463/20

(57) ABSTRACT

In a gaming machine according to the present invention, a reel assembly includes a lighting unit, a lighting driver unit, and a color check unit, as well as a reel and a motor. The lighting unit emits colored rays to a symbol displayed on a visible region on a reel. The lighting driver unit adjusts driving currents for the lighting unit in accordance with a control signal. The color check unit generates an error signal when detecting that the level of any driving current falls outside a predetermined range. A game control unit conducts a game by randomly changing arrangements and colors of the visible symbols. A lighting control unit provides the control signal to the lighting driver unit. If receiving the error signal from the color check unit, the lighting control unit informs the game control unit of an error state of the lighting unit.

### BACKGROUND OF THE INVENTION

1. Field of the Invention

The present invention relates to a gaming machine, and in particular a machine comprising mechanical reels like a reel slot machine.

2. Background Information

Gaming machines such as slot machines, poker machines, fruit machines, and the like generally attract enormous popularity from players in casinos. These types of gaming machines display an arrangement of symbols on the front thereof, and change the types of symbols in the arrangement at random. A player guesses on which line of the arrangement (i.e. payline) a specific combination of symbols (i.e. winning combination) will appear, and places a bet on the payline before the symbols are changed in the arrangement. If a winning combination appears on the payline on which the player has placed a bet, the player will win an amount of a payout that depends on the amount of the bet and the type of the winning combination.

These types of gaming machines are generally equipped with mechanical reels that are coaxially arranged and allowed to independently spin by means of respective motors. Symbols are permanently displayed on the circumferential surfaces on each reel in a predetermined order. The reels repeat spins and stop, and thereby change the visible symbols. Alternatively, the above types of gaming machines may be equipped with an electric display device in which symbols are arranged in graphic form (i.e. video reel) on a screen of the display device.

In general, the chances of winning larger payouts can attract a larger number of players to gaming machines. Gaming machines with mechanical reels can however provide limited amounts of payouts, in contrast to gaming machines with video reels, since the number of symbols per mechanical reel is limited by the sizes of the reels and cabinets of the gaming machines. On the other hand, many players prefer real and simple three-dimensional motions of symbols caused by the rotation of the mechanical reels to unpredictably extensive and complex changes in symbols on video reels. Accordingly, a gaming machine with mechanical reels is desired that can increase the variety of symbols so as to exceed the number thereof otherwise limited by the sizes of the reels and cabinets of the gaming machines.

There is a prior art gaming machine with mechanical reels that changes the illumination of each symbol in color or pattern in order to increase the variety of the symbols (e.g., U.S. Pat. Nos. 6,027,115 and 6,056,642). The gaming machine deals with a symbol illuminated with a different color or a different pattern as a different type of symbol. Accordingly, the number of symbol types per reel will be increased by the number of colors or patterns available times the actual number of symbols displayed on each reel. The wider variety of symbols allows the gaming machine to expand the range of odds in games, and in particular raise the upper limit of payouts, regardless of the sizes of the reels and cabinets of the gaming machine. Thus, the gaming machine can attract a larger number of players to play games thereon.

In order to determine whether or not a game has been won based upon a single symbol having a different type depending on the color or pattern of illumination thereof, a gaming machine has to ensure exact consistency between the color or pattern of illumination and the type of the symbol. However, there is no known gaming machine that can ensure exact consistency in a clear and simple manner.

In view of the above, it will be apparent to those skilled in the art from this disclosure that there exists a need for an improved gaming machine with mechanical reels, which can deal with each symbol as a different type depending on the color or pattern of illumination in order to increase the variety of symbols, and ensure exact consistency between the types of symbols and the colors or patterns of illumination. This invention addresses this need in the art as well as other needs, which will become apparent to those skilled in the art from this disclosure.

### SUMMARY OF THE INVENTION

A gaming machine according to the present invention comprises a plurality of reel assemblies, a game control unit, a reel control unit, and a lighting control unit.

Each of the reel assemblies comprises a motor, a reel, a lighting unit, a lighting driver unit, and a color check unit. The motor includes a shaft. The reel is a mechanical reel configured to be rotatably coupled to the shaft. A series of symbols is displayed on the circumferential surface of the reel. The lighting unit is configured to emit two or more types of colored rays of light in response to driving currents, and illuminate a predetermined region of the circumferential surface of the reel by using the colored rays. The lighting unit preferably comprises at least two red, green, and blue light emitting diodes (LEDs). A single symbol is preferably placed in the predetermined region on each stopped reel, and thereby illuminated with the colored rays. The lighting driver unit is configured to provide the lighting unit with the driving currents in accordance with a control signal received from the exterior thereof. The driving currents adjusted by the lighting driver unit change the intensity of the colored rays emitted from the lighting unit, and thereby determine the color or pattern of the symbol illuminated in the above region on each stopped reel. The color check unit is configured to monitor the levels of the driving currents. Here, the desired levels of the driving currents are predetermined from the desired colors or patterns of the illuminated symbols. Accordingly, the driving currents maintained at the desired levels represent the consistency between the actual colors/patterns of the illuminated symbols and the desired ones. In view of this, the color check unit is further configured to generate an error signal when detecting that one of the levels of the driving currents falls outside a predetermined range. This enables the gaming machine to immediately detect the inconsistency between the actual colors/patterns of the illuminated symbols and the desired ones.

The color check unit preferably comprises a current detector unit, a comparator unit, and an error notification unit. The current detector unit is configured to check whether or not the levels of the driving currents fall within their respective, predetermined ranges. The comparator unit is configured to check whether or not consistency is maintained between the control signal and the output of the current detector unit. The error notification unit is configured to generate the error signal when the output of the comparator unit indicates inconsistency between the control signal and the output of the current detector unit. The control signal generally indicates the desired levels of the driving currents during a predetermined interval. If the current detector unit detects that a driving current has excessively deviated from its desired level in the predetermined interval in a manner inconsistent with the control signal, the actual colors/patterns of the illuminated symbols are undoubtedly inconsistent with the desired ones. Thus, the color check unit can detect the inconsistency in colors/patterns of the illuminated symbols with high reliability.

The game control unit is configured to conduct a game by using an arrangement of the symbols displayed on a visible region of the circumferential surfaces of the reels. The reel control unit is configured to command the motor to spin the reel and stop the reel at a predetermined position under control of the game control unit. The lighting control unit is configured to provide the lighting driver unit with the control signal under control of the game control unit. In particular, the lighting control unit controls the lighting driver unit to illuminate symbols placed on the visible region on each stopped reel with the desired colors/patterns. Here, the desired colors/patterns of illumination are preferably predetermined from the symbol types selected by the game control unit as symbols to be displayed on the visible region on each stopped reel. The lighting control unit can check the consistency between the actual colors/patterns of the illuminated symbols and the desired ones through the error signal. If receiving the error signal from the color check unit, the lighting control unit preferably informs the game control unit of an error in the lighting unit. The game control unit will then take appropriate steps to inform the player and an attendant of the error, e.g., it will cause the reel control unit to continuously revolve the reels in order not to stop them at any position. Thus, the gaming machine immediately detects the inconsistency between the types of symbols and the colors or patterns of illumination, and thereby ensures exact consistency therebetween during the normal condition.

The lighting driver unit is preferably configured to control the intensity of the colored rays by pulse modulation of the driving currents. More preferably, the lighting driver unit comprises a switching device configured to conduct or cut off the driving current, and the lighting driver unit is configured to turn on or off the switching device in response to the control signal. In that case, the color check unit is preferably configured to monitor the pulse levels of the driving currents. The desired pulse shapes of the driving currents, in particular the desired activation timing thereof, are predetermined by the desired colors or patterns of the illuminated symbols. Accordingly, the color check unit can immediately detect the inconsistency between the actual colors/patterns of the illuminated symbols and the desired ones from the detection that the pulse level of the driving current falls outside the predetermined range.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of the external appearance of a gaming machine according to an embodiment of the present invention;

FIG. 2 is a block diagram of the configuration of the gaming machine shown in FIG. 1;

FIG. 3 is a perspective view of a reel assembly according to the embodiment of the present invention;

FIG. 4 is an exploded perspective view of the reel assembly shown in FIG. 3;

FIG. 5 is a block diagram of the control system of the lighting unit included in the reel assembly shown in FIG. 3; and

FIGS. 6A-6G are timing charts of signals used in the control system shown in FIG. 5.

### BEST MODE FOR CARRYING OUT THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

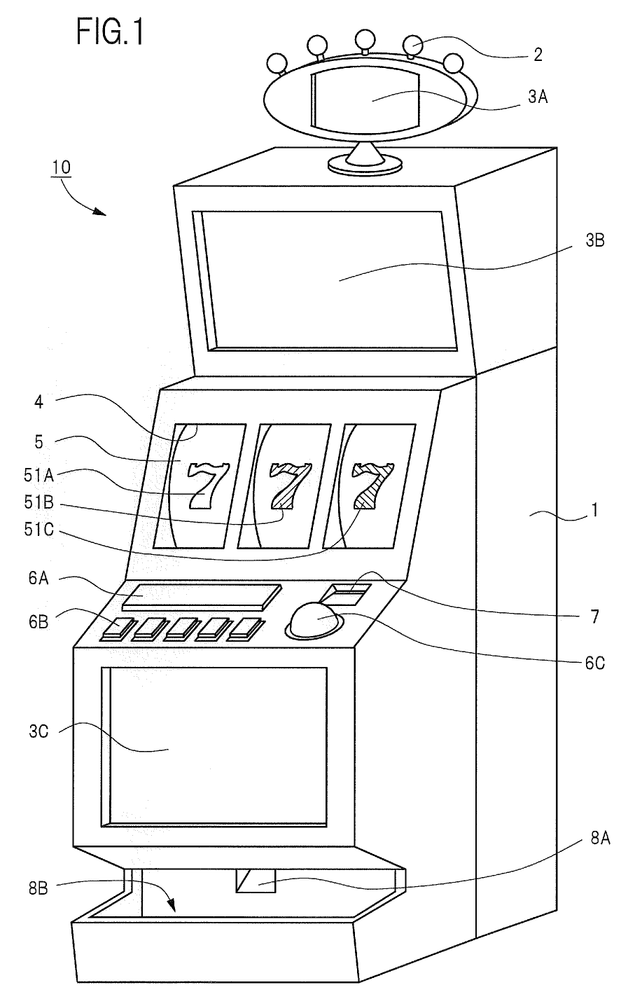

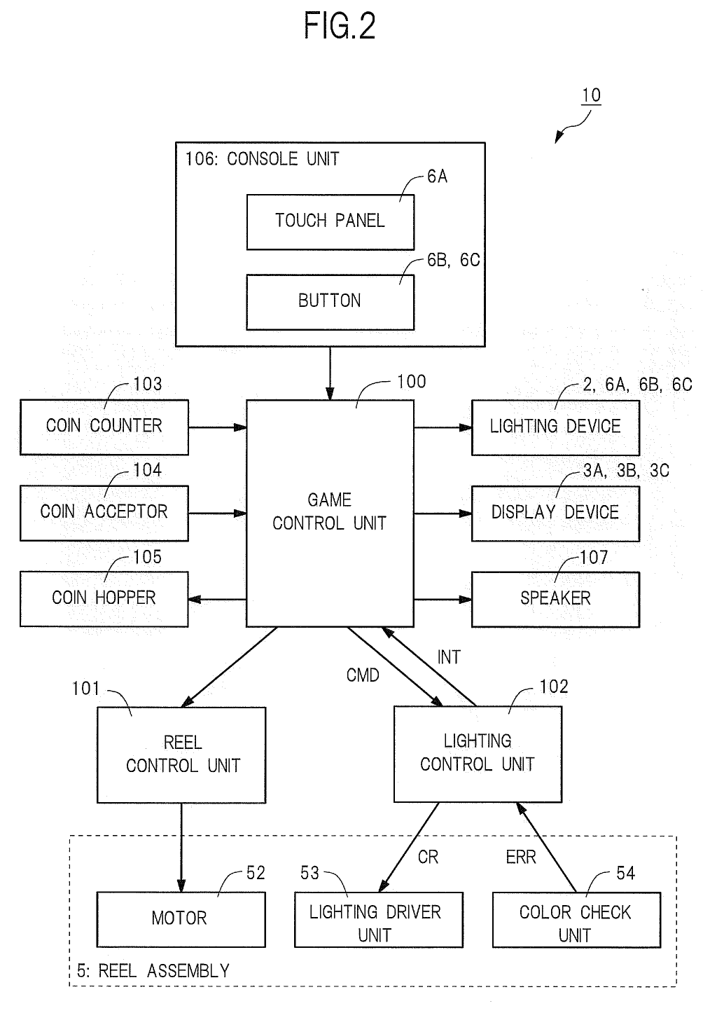

A gaming machine according to an embodiment of the present invention is preferably of a standalone type and installed in a casino. Alternatively, the gaming machine may be of a download type or a thin-client type and controlled by a server through a LAN. The gaming machine 10 is preferably a stepper-reel slot machine as shown in FIGS. 1 and 2. As shown in FIG. 1, the components of this slot machine visible from the exterior include a cabinet 1, lamps 2, display devices 3A, 3B, 3C, reel assemblies 5, a touch panel 6A, operation buttons 6B, a spin button 6C, a coin/bill slot 7, a coin chute 8A, and a coin tray 8B. As shown in FIG. 2, the components of this slot machine mounted inside the cabinet 1 and invisible from the exterior include a game control unit 100, a reel control unit 101, a lighting control unit 102, a coin counter 103, a coin acceptor 104, a coin hopper 105, a console unit 106, and a speaker 107.

The lamps 2 are illumination lights mainly for use as decoration and visual effects in games; they can blink and/or change brightness and color in specific patterns. The lamps 2 may be mounted on, for example, the top of the cabinet 1, as shown in FIG. 1, and in addition, the front, sides, and rear of the cabinet 1.

The display devices 3A, 3B, and 3C each receive external image data, and reproduce images which correspond to the image data. The images include, for example, images for use in decoration, such as the image of a logo of a game developer, images for use in advertisements, images for use in visual effects in games and the display of information about games, such as pay tables, illustrations of game content, the amount of a bet, the number of credits available, and a jackpot meter.

The display window 4 is comprised of a plurality of holes provided in front of the cabinet 1 as shown in FIG. 1. Each hole is preferably covered with glass. Behind the display windows 4, the three or more reel assemblies 5 are coaxially arranged. Each reel assembly 5 has a mechanical reel rotatable around the center axis thereof. The rotation angle and speed of each reel are preferably controlled by a motor 52 (cf. FIG. 2) installed in each reel assembly 5. The motor 52 is preferably a stepping motor coupled to the center axis of each reel, and controlled by the reel control unit 101. As shown in FIG. 1, the portion of the circumferential surface of the reel 5 is visible through each display window 4 from the front (player's side) of the cabinet 1. A plurality of symbols is displayed on the circumferential surface of each reel 5, and a few of the symbols 51A, 51B, and 51C are visible through each display windows 4. Different symbols appear in each display window 4, depending on the rotation angle of the reel 5. The visible portion of the circumferential surface of each reel 5 is illuminated by a lighting unit installed in each reel assembly 5. The lighting unit emits two or more types of colored rays of light (not shown in FIGS. 1 and 2). A lighting driver unit 53 (cf. FIG. 2) drives the lighting unit in accordance with control signals CR received from the lighting control unit 102, and thereby changes in color and/or pattern the illumination of each visible symbol 51A, 51B, and 51C. The same symbols illuminated with different colors and/or patterns (e.g., the same “7” symbols with different colors 51A, 51B, and 51C shown in FIG. 1) are dealt with as different symbol types. Accordingly, the number of the symbol types visible on each reel 5 is several times as many as the number of the symbols actually displayed on the reel 5, depending on the number of the colors and/or patterns that the lighting unit can express.

Input devices such as the touch panel 6A, the operation buttons 6B, and the spin button 6C (cf. FIG. 1) are connected to the console unit 106 (cf. FIG. 2), which accepts various kinds of instructions from a player through the input devices. The instructions in particular include a request for a game program selected by a player and an instruction from a player to change game status. The touch panel 6A preferably displays a keyboard image and a numeric keypad image thereon, thereby allowing a player to enter characters and numerals. The operation buttons 6B and the spin button 6C are lamp buttons, which include LEDs and light up when pushed. A player selectively pushes the operation buttons 6B, preferably in order to select paylines and the amount of a bet. A player pushes the spin button 8 in order to cue the reels 5 for the start of a spin.

A player enters coins and bills into the coin/bill slot 7 (cf. FIG. 1). The coin counter 103 (cf. FIG. 2) counts the coins and bills. The coin acceptor 104 validates the coins and bills. The total amount of the validated coins and bills are displayed, for example, on the middle display device 3B as credits available to the player. The coin hopper 105 holds a large number of coins, and discharges the coins equivalent to the credits that the player has won on a game from the coin chute 8A into the coin tray 8B. The speaker 107 is installed inside the cabinet 1, and generates voice announcements and sound effects under control of the game control unit 100.

The game control unit 100 is preferably comprised of a microcomputer including a CPU, a ROM, and a RAM. Preferably, the microcomputer also serves as the reel control unit 101 and the lighting control unit 102. Alternatively, the control units 100, 101, and 102 may be separately composed of distinct pieces of hardware. The game control unit 100 stores a game program. When receiving a cue for the start of a game from a player through the console unit 106 (e.g., when the player enters coins/bills into the coin/bill slot 7), the game control unit 100 invokes the game program. After that, the game control unit 100 conducts the game according to the executed game program, and in particular, controls the above-described components installed on the gaming machine 10, depending on the game status as follows.

When a player enters coins/bills into the coin/bill slot 7, the game control unit 100 detects and accepts the coins/bills through the console unit 106, and then increases the credits of the player by the count provided by the coin counter 103. In parallel with that, the game control unit 100 starts to produce visual and sound effects by using the lighting devices 2, 6A, 6B, 6C, the display devices 3A, 3B, 3C, and the speaker 107. The player selects paylines and places a bet by using the touch panel 6A and/or the buttons 6B. The game control unit 100 detects the paylines and the bet accepted by the console unit 106, and then decreases the credits by the amount of the bet, and displays the amounts of the bet and the available credits, and the selected paylines on the display devices 3A, 3B, and/or 3C. When the console unit 106 detects that the player has pushed the spin button 6C, the game control unit 100 then causes the reel control unit 101 to command the motor 52 of each reel assembly 5 to spin the reel. In synchronization with the spin, the game control unit 100 commands the lighting control unit 102 to control the lighting driver unit 53 of each reel assembly 5 to change the colors/patterns with which the lighting unit in each reel assembly 5 illuminates the visible region on the reel. On the other hand, the game control unit 100 randomly determines symbols to be displayed at the visible region on each reel when stopped, i.e., a position (rotation angle) at which each reel will be stopped, and the colors/patterns with which the lighting unit in each reel assembly 5 will illuminate the visible region on the stopped reel. Furthermore, the game control unit 100 checks a winning combination of symbols in the symbols to be arranged on the visible region on the stopped reels, and thereby determines whether or not to provide an award to the player. After a predetermined time has elapsed from the start of the spin, the game control unit 100 causes the reel control unit 101 to stop the reels at the predetermined positions. If a winning combination that represents an amount of a payout is detected, the game control unit 100 will increase the credits of the player by the payout, or causes the coin hopper 105 to discharge the coins equivalent to the payouts. In addition, the game control unit 100 controls the lighting devices 2, 6A, 6B, 6C, the display devices 3A, 3B, 3C, and the speaker 107 to produce visual and sound effects to announce the winning of the payout.

In determining whether or not a win has occurred, a single symbol is dealt with as a different type depending on the color or pattern of illumination. In this case, the gaming machine 100 has to ensure exact consistency between the actual colors/patterns of the illuminated symbols and the symbol types that the game control unit 100 identifies as the illuminated symbols. Here, the gaming control unit 100 predetermines and stores the relationship between colors/patterns of illumination and symbol types. The lighting control unit 102 uses a color check unit 54 installed in each reel assembly 5 in order to check the consistency between the actual colors/patterns of the illuminated symbols and the symbol types that the game control unit 100 identifies. The color check unit 54 monitors the driving current provided to each lighting unit under control of the lighting driver unit 53. The color check unit 54 further generates an error signal ERR when detecting a driving current that indicates an inconsistency between the actual color/pattern of the illuminated symbol and the desired one. If an error signal ERR is received from the color check unit 54, the lighting control unit 102 immediately informs the game control unit 100 of an error in the lighting unit, preferably by using an interrupt request INT. The game control unit 100 will then take appropriate steps to inform the player and the attendant of the error, e.g., the unit will cause the reel control unit 101 to continuously revolve the reels in order not to stop them at any position. Thus, the gaming machine 10 immediately detects the inconsistency between the symbol types and the colors/patterns of illumination, and thereby ensures exact consistency therebetween during normal conditions.

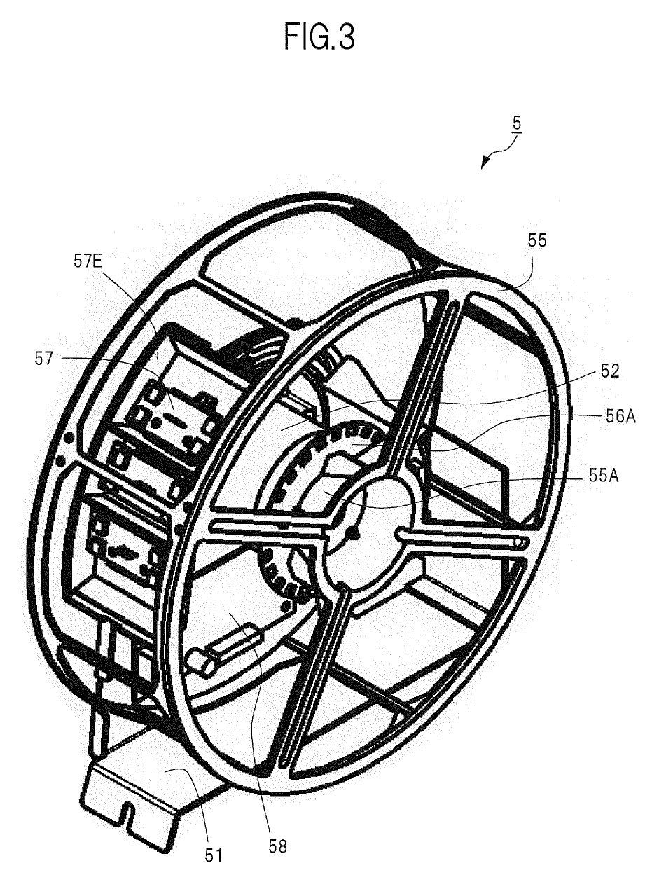

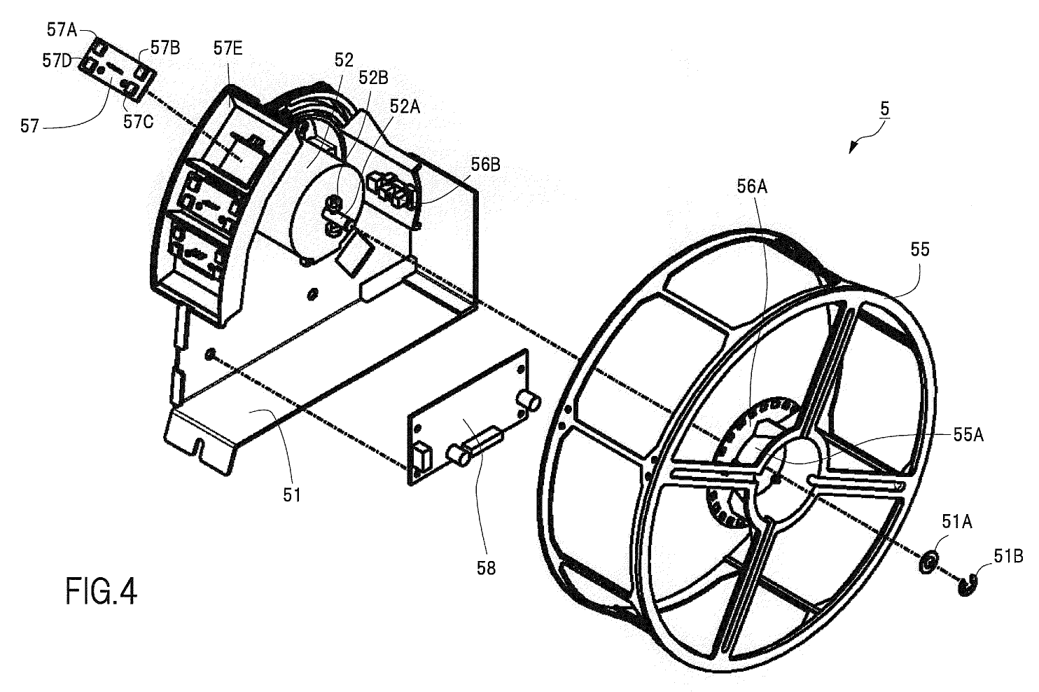

As shown in FIGS. 3 and 4, each of the reel assemblies 5 comprises a supporting member 51, a motor 52, a mechanical reel 55, a rotary encoder 56A, 56B, a plurality of lighting units 57, and a circuit board 58.

The supporting member 51 is fixed inside the cabinet 1 behind each display window 4 (cf. FIG. 1). The motor 52 is mounted on the supporting member 51. The shaft 52A of the motor 52 has two branches perpendicular to the shaft 52A fixed at the base thereof, and a female thread formed at the tip thereof. An elastic member 52B, preferably an O-ring made of an elastomer, is positioned around each of the branches of the shaft 52A.

The reel 55 is preferably a plastic drum, the whole of which is integrally molded, or parts of which are separately molded and combined into one. The symbols such as 51A, 51B, and 51C shown in FIG. 1 are preferably printed on a strip of transparent paper, or alternatively may be displayed on a flexible display device (e.g., flexible LCD, organic electroluminescent display device (OLED), or electric paper). The strip of paper or the flexible display device is wound around the reel 55 to constitute the circumferential surface thereof.

The shaft 52A of the motor 52 is inserted in a hole opened at the center portion 55A of the reel 55 along the center axis thereof. A hollow is formed at the surface of the center portion 55A opposed to the front surface of the motor 52 (not shown in FIGS. 3 and 4). The elastic members 52B fit in the hollow, and can deform in the axial and circumferential directions of the shaft 52A. The shaft 52A passes through the hole of the center portion 55A, and a washer 51A in that order. A screw 51B is coupled to the female thread at the tip of the shaft 52A. The screw 51B then presses the center portion 55A of the reel 55 in the axial direction, and thereby secures the reel 55 on the shaft 52A. The motor 52 rotates the reel 55 around its center axis under control of the reel control unit 101 (cf. FIG. 2). In particular, the motor 52 exerts torque on the reel 55 through circumferential compression of the elastic members 52B. In this case, the circumferential deformation of the elastic members 52B absorbs circumferential vibrations of the reel 55 quickly and reliably at a stop position.

The rotary encoder comprises a disk 56A, an LED, and a photodetector 56B. The disk 56A is coaxially fixed at the surface of the center portion 55A of the reel 55. A number of slots are uniformly spaced along the rim of the disk 56A. The LED and the photodetector 56B are mounted on the inner surface of the supporting member 51, and opposed to each other. The LED emits a ray of light, and the photodetector detects the ray. Between the pair, the rim of the disk 56A is placed. While each slots of the disk 56A passes between the pair, the photodetector can detect the ray emitted from the LED. Otherwise, the rim of the disk 56A cuts off the ray and prevents the photodetector 56B from detecting the ray. The reel control unit 101 measures the number and frequency of output pulses sent from the photodetector 56B, and thereby monitors the current position (i.e., rotation angle) and the rotation speed of the reel 55.

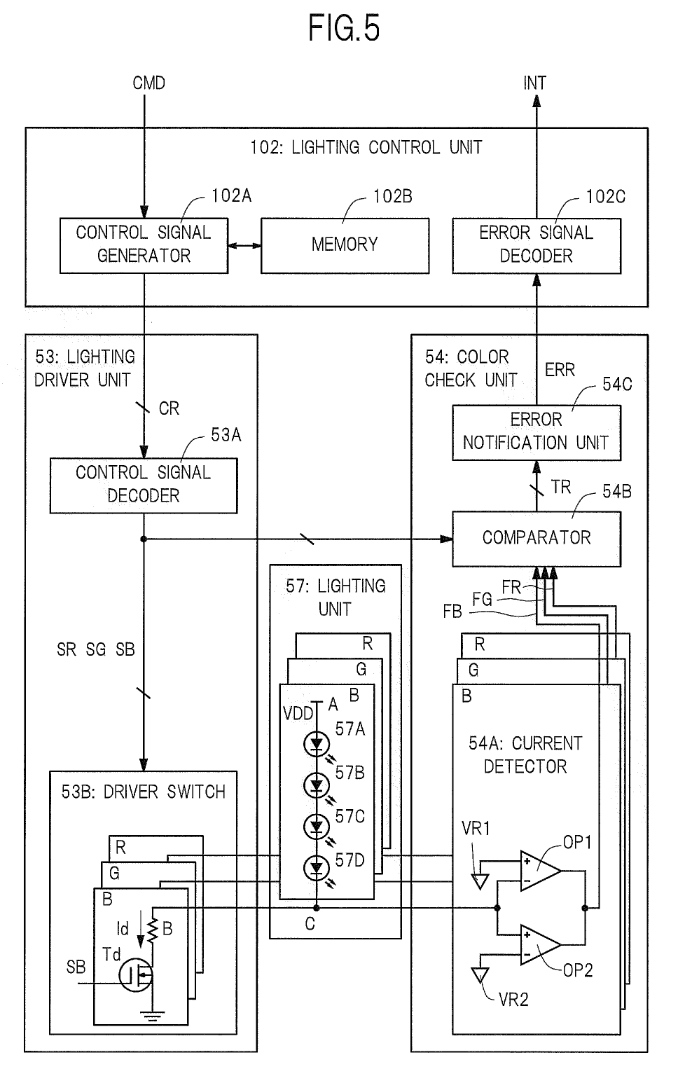

The lighting unit 57 preferably comprises four LED units 57A, 57B, 57C, and 57D mounted on a small circuit board. Each of the LED units 57A, 57B, 57C, and 57D preferably comprises at least two LEDs selected from the group consisting of red, green, and blue LEDs, and more preferably comprises all of these LEDs. Note that the number of each color LED is preferably one per LED unit, but may be freely adjusted. In each of the lighting units 57, the same color LEDs are connected in series, and driven by a common driving current Id (cf. FIG. 5). In other words, each of the lighting units 57 comprises three types (red, green, and blue) of (four-) series LEDs. A housing 57E are mounted on the supporting member 51, and opposed to the inner circumferential surface of the reel 55 visible through the display window 4 (cf. FIG. 1). The lighting units 57 are placed inside the housing 57E. The four LED units 57A, 57B, 57C, and 57D on each of the lighting units 57 illuminate a predetermined region in the visible portion of the circumferential surface of the reel 55 from the inside thereof. In FIGS. 3 and 4, three separate regions in the visible portion of the reel 55 are illuminated by the respective lighting unit 57. While the reel 55 is stopped, a single symbol is positioned in each of the regions, and then three symbols per reel are illuminated by the respective lighting units 57.

Note that the number of the lighting units and the number of the LED units per lighting unit may be freely adjusted. In particular, a matrix of LEDs may be mounted on each lighting unit. In the case where symbols are displayed on a flexible LCD mounted on the reel 55, the lighting units 57 may be replaced with the backlight unit of the LCD. In the case where symbols are displayed on an OLED mounted on the reel 55, the OLED may serve as lighting units.

The circuit board 58 is preferably mounted on the inner surface of the supporting member 51. The lighting driver unit 53 and the color check unit 54 shown in FIG. 2 are implemented on the circuit board 58. The lighting driver unit 53 preferably controls the intensity of the colored rays emitted from the lighting units 57 by pulse modulation of the driving currents Id, in collaboration with the lighting control unit 102. The color check unit 54 preferably monitors the pulse levels of the driving currents Id, and thereby detects an excessive deviation in activation timing of any driving current Id (details will be described below).

As shown in FIG. 5, the lighting control unit 102 preferably comprises a control signal encoder unit 102A and a memory unit 102B.

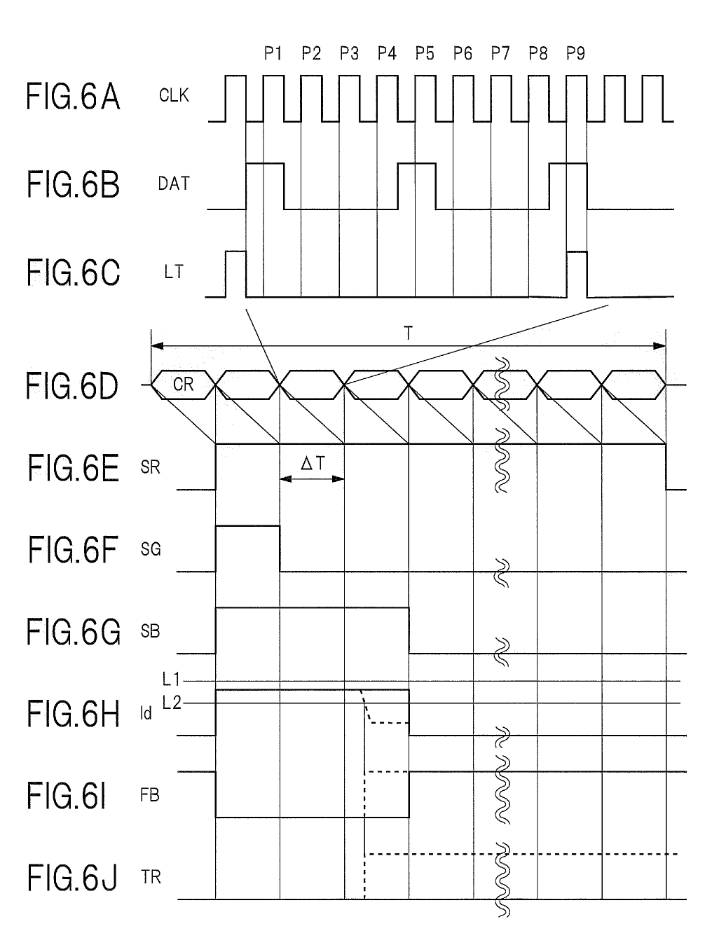

The control signal encoder unit 102A receives a command CMD from the game control unit 100, and then generates a group of LED control signals CR according to the command CMD (cf. FIG. 6D). The command CMD represents target brightness levels of the LEDs included in the LED units 57A, 57B, 57C, and 57D on all the lighting units 57. Here, the target brightness levels are preferably expressed with a predetermined number of gradation steps (e.g., 32). The LED control signals CR represent ON/OFF states of all the LEDs at regular unit intervals ΔT (e.g., ΔT=0.5 msec in FIG. 6D). The control signal encoder unit 102A periodically repeats the transmission of the LED control signals CR at intervals T of the number of gradation steps (e.g., 32) times the unit interval ΔT (i.e., T=32 ΔT=15.5 msec in FIG. 6D) until receiving the next command CMD from the game control unit 100. The LED control signals CR preferably comprises a clock signal CLK, a data signal DAT, and a latch signal LT (cf. FIGS. 6A, 6B, and 6C, respectively). The clock signal CLK preferably comprises the same number of pulses P1, P2, . . . , in each unit interval ΔT as the total number of the series LEDs including in all the lighting units 57 (e.g., 9=3×3 in FIG. 6A). Each of the pulses P1, P2, . . . , included in the unit interval ΔT is assigned to one of the series LEDs. In FIGS. 1 and 6A, for example, the nine pulses P1, P2, . . . , P9 are assigned to the red, green, and blue series LEDs of the top lighting unit 57, the red, green, and blue series LEDs of the middle lighting unit 57, and the red, green, and blue series LED of the bottom lighting unit 57, respectively. The assertion or negation of the data signal DAT at the rising edge of each pulse of the clock signal CLK represents the ON or OFF state of the series LED assigned to the pulse. In FIGS. 6A and 6B, for example, the data signal DAT is asserted at the rising edges of the first pulse P1, the fifth pulse P5, and the ninth pulse P9 of the clock signal CLK. This represents the turning ON of the red series LED of the top lighting unit 57, the green series LED of the middle lighting unit 57, and the blue series LED of the bottom lighting unit 57, and the turning OFF of the other series LEDs during the next unit interval ΔT. The latch signal LT (in particular, the falling edges thereof in FIG. 6C) represents boundaries between the adjacent unit intervals ΔT.

The memory unit 102B stores the links between the brightness levels represented by the command CMD and the patterns of the data signal DAT during the large interval T. The control signal encoder unit 102A accesses the memory unit 102B to retrieve the pattern of the data signal DAT linked to the brightness levels decoded from the received command CMD.

As shown in FIG. 5, the lighting driver unit 53 comprises a control signal decoder unit 53A and a driver switch unit 53B.

The control signal decoder unit 53A receives the LED control signals CR from the control signal encoder unit 102A, and then generates switching signals SR, SG, and SB based on the LED control signals CR. More specifically, the control signal decoder unit 53A first detects the states of the data signal DAT at the rising edges of the pulses P1, P2, . . . of the clock signal CLK at intervals between the two adjacent pulses of the latch signal LT. The control signal decoder unit 53A then asserts or negates each of the switching signals SR, SG, and SB during the next unit interval ΔT. Here, the switching signals preferably comprise the same number of types SR, SG, SB, . . . as the total number of the series LEDs included in all the lighting units 57 (e.g., 9=3×3 in FIG. 6A). Each type of the switching signals SR, SG, and SB is assigned to one of the pulses P1, P2, . . . included in the unit interval ΔT, and accordingly one of the series LEDs. In FIGS. 6E, 6F, and 6G, for example, the three types SR, SG, and SB are assigned to the red, green, and blue series LEDs of one of the lighting units 57, respectively. Depending on whether the data signal DAT is asserted or negated at the rising edge of each pulse P1, P2, . . . of the clock signal CLK, the control signal decoder unit 53A asserts or negates the corresponding switching signals SR, SG, and SB during the next unit interval ΔT. In FIGS. 6E, 6F, and 6G, for example, the red switching signal SR is asserted throughout the large interval T, the green switching signal SG is asserted only during the first unit interval ΔT included in the large interval T, and the blue switching signal SB is asserted during the first through third unit intervals ΔT included in the large interval T.

The driver switch unit 53B comprises the same number of switching devices Td as the total number of the series LEDs 57A-57D included in all the lighting units 57 (e.g., 9=3 ×3 in FIG. 6A). Each of the switching devices Td are connected between a ground terminal and the cathode C of one of the series LEDs 57A-57D. Here, the anode A of each series LED 57A-57D is maintained at a high voltage VDD. The switching device Td conducts and cuts off the driving current Id flowing through the series LED 57A-57D. The switching devices Td are preferably FETs, or alternatively may be bipolar transistors or photocouplers. The control terminal of each switching devices Td (e.g., the gate of a FET) receives one of the switching signals SR, SG, and SB, and thus the switching device Td is turned ON and OFF when the received switching signal SR, SG, or SB is asserted and negated, respectively. During the ON and OFF time of the switching device Td, the driving current Id flows and stops flowing through the series LED 57A-57D connected to the switching device Td, respectively (cf. FIG. 6H), and accordingly the series LED 57A-57D are turned ON and OFF, respectively. In FIGS. 6E, 6F, and 6G, for example, the first switching device Td received the red switching signal SR is turned ON throughout the large interval T, the second switching device received the green switching signal SG is turned ON only during the first unit interval ΔT included in the large interval T, and the first switching device Td received the blue switching signal SB is turned ON during the first through third unit intervals ΔT included in the large interval T. Accordingly, in the lighting unit 57, the red series LED is turned ON throughout the large interval T, the green series LED is turned ON only during the first unit interval ΔT included in the large interval T, and the blue series LED is turned ON during the first through third unit intervals ΔT included in the large interval T. Thus, the duty ratio (i.e., the brightness level) of each series LED in the large interval T is adjusted with the same number of gradation steps (e.g., 32) as the pulse number of the latch signal LT in the large interval T. The combination of duty ratios between the red, green, and blue series LEDs determines the actual color of light emitted by the lighting unit 57, i.e., the color of the symbol illuminated by the lighting unit 57.

The color check unit 54 comprises a current detector unit 54A, a comparator unit 54B, and an error notification unit 54C.

The current detector unit 54A comprises pairs of comparator devices OP1 and OP2, and pairs of reference voltage sources VR1 and VR2. The number of each pair is equal to the total number of the series LEDs 57A-57D including in all the lighting units 57 (e.g., 9=3×3 in FIG. 6A). The comparator devices OP1 and OP2 are preferably operational amplifiers. The positive and negative input terminals of the first comparator device OP1 are respectively connected to the first reference voltage source VR1 and the cathode C of one of the series LEDs 57A-57D. The positive and negative input terminals of the second comparator device OP2 are respectively connected to the cathode C of the same series LED 57A-57D and the second reference voltage source VR2. In this case, a specific resistor R is preferably connected between the cathode C and the switching device Td. While the driving current Id flows through the resistor R, the voltage VC at the cathode C is substantially maintained at the level of the driving current Id times the resistance of the resistor R. The first comparator device OP1 compares the voltage VC at the cathode C with the first reference voltage VR1. If the voltage VC exceeds the first reference voltage VR1, i.e., the driving current Id exceeds an upper limit L1 corresponding to the first reference voltage VR1 (cf. FIG. 6H), the first comparator device OP1 asserts its output signal. If the voltage VC falls below the second reference voltage VR2, i.e., the driving current Id is reduced below a lower limit L2 corresponding to the second reference voltage VR2 (cf. FIG. 6H), the second comparator device OP2 asserts its output signal. The output signals of the comparator devices OP1 and OP2 form a feedback signal FR, FG, or FB, preferably through a wired-OR connection. When the output signal of either comparator device OP1 or OP2 is asserted, the feedback signal is asserted. Thus, the current detector unit 54A generates the feedback signals FR, FG, and FB that represent whether or not the levels of the driving currents Id fall within the predetermined ranges corresponding to the ranges between the two reference voltages VR1 and VR2.

Note that the reference voltages VR1 and VR2 have different values for the different series LEDs, and accordingly the different ranges of the driving currents Id are acceptable for the different series LEDs. In addition, the feedback signal is asserted while the driving current Id is normally cut off. Accordingly, for each series LED, the feedback signal rises and falls at the rising and falling edge of the driving current Id, respectively (cf. FIGS. 6H and 6I).

The comparator unit 54B is preferably implemented in a programmable logic device. The comparator unit 54B receives switching signals SR, SG, and SB from the control signal decoder 53A, and feedback signals FR, FG, and FB from the current detector unit 54A. The comparator unit 54B then pairs each switching signal with one of the feedback signals that follows the driving current Id conducted and cut off by the switching device Td according to the switching signal. The comparator unit 54B monitors the states of each pair of the switching and feedback signals.

In normal conditions, each driving current Id rises and falls respectively at the rising and falling edges of the switching signal that controls the switching device Td to conduct and cut off the driving current Id (cf. the solid lines shown in FIGS. 6G and 6H). Accordingly, the feedback signal caused by the driving current Id falls and rises at the rising and falling edges of the switching signal, respectively (cf. the solid lines shown in FIGS. 6H and 6I). Therefore, each pair of the switching and feedback signals maintains opposite states (i.e., one of the signals is asserted and the other is negated) during normal conditions.

If one of the driving currents Id accidentally rises or falls in a manner inconsistent with the control signal CR, the series LED through which the driving current Id flows will emit a colored ray having an intensity different from the desired one indicated by the control signal CMD. This can improperly change the color of the symbol illuminated by the series LED. In FIGS. 6G and 6H, for example, the driving current Id that flows through a blue series LED is accidentally reduced below the lower limit L2 in the third unit interval ΔT (cf. the broken lines shown in FIG. 6H), while the switching signal SB is asserted from the start of the first unit interval to the end of the third unit interval. In that case, the blue series LED will stop emitting a blue ray before the end of the third unit interval, and accordingly the actual brightness level thereof will not reach the desired one indicated by the control signal CMD.

On the other hand, the accidental rising and falling of the driving current Id simultaneously causes the corresponding feedback signal to fall and rise, respectively. In FIGS. 6H and 61, for example, the corresponding feedback signal FB is asserted at the same time when the driving current Id is reduced below the lower limit L2 in the third unit interval ΔT (cf. the broken lines shown in FIGS. 6H and 61). As a result, the pair of the switching and feedback signals maintains the same state (i.e., both of the signals are asserted or negated) after the accidental rising or falling of the driving current Id (cf. the solid lines shown in FIG. 6G and the broken lines shown in FIG. 6I). The comparator unit 54B detects that any pair of the switching and feedback signals maintains the same state, and then asserts a trigger signal TR (cf. the broken lines shown in FIG. 6J). Preferably, the number of the trigger signals TR is equal to the number of the feedback signals FR, FG, and FB, i.e., the total number of the series LEDs 57A-57D. Thus, the comparator unit 54B can check whether or not consistency is maintained between the control signal CMD and the feedback signals, i.e., the output of the current detector unit 57A.

The error notification unit 54C receives the trigger signals TR from the comparator unit 54B, and then encodes the error signal ERR with the data on the series LEDs in an error state. The error notification unit 54C preferably performs serial transmission, i.e., the bits of the error signal ERR are transmitted over a single line. The lighting control unit 102 further comprises an error signal decoder 102C (cf. FIG. 5). The error signal decoder 102C receives the error signal ERR from the error notification unit 54C, and decodes the data on the series LEDs in an error state from the error signal ERR. The error signal decoder 102C then generates an interrupt request INT to inform the game control unit 100 of the data on the series LEDs in an error state. The game control unit 100 will then take appropriate steps to inform the player and the attendants of the error state, e.g., it will cause the reel control unit 101 to continuously revolve the reels 55 in order not to stop them at any position. Thus, the gaming machine 10 immediately detects the inconsistency between the types of symbols and the colors or patterns of illumination, and thereby ensures the exact consistency therebetween during the normal condition.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A reel assembly comprising:
a motor including a shaft;
a reel configured to be rotatably coupled to the shaft, and comprising a circumferential surface on which a series of symbols is displayed;
a lighting unit configured to emit two or more types of colored rays of light in response to driving currents, and illuminate a predetermined region of the circumferential surface of the reel by using the colored rays;
a lighting driver unit configured to allow the driving currents to flow in the lighting unit in response to a control signal received from the exterior thereof, and
a color check unit configured to monitor the levels of the driving currents, and generate an error signal when detecting that one of the levels falls outside a predetermined range.

2. A reel assembly according to claim 1, wherein the lighting unit comprises two or more LEDs selected from the group consisting of red, green, and blue LEDs.

3. A reel assembly according to claim 1, wherein the lighting driver unit is configured to control the intensity of the colored rays emitted from the lighting unit by pulse modulation of the driving currents.

4. A reel assembly according to claim 1, wherein the lighting driver unit comprises a switching device configured to conduct or cut off the driving current; and
the lighting driver unit is configured to turn on or off the switching device in response to the control signal.

5. A reel assembly according to claim 1, wherein the color check unit comprises:
a current detector unit configured to check whether or not the levels of the driving currents fall within their respective, predetermined ranges;
a comparator unit configured to check whether or not timing consistency is maintained between the control signal and the output of the current detector unit; and
an error notification unit configured to generate the error signal when the output of the comparator unit indicates timing inconsistency between the control signal and the output of the current detector unit.

6. A gaming machine comprising:
a plurality of reel assemblies, each reel assembly comprising:
a motor including a shaft;
a reel configured to be rotatably coupled to the shaft, and comprising a circumferential surface on which a series of symbols is displayed;
a lighting unit configured to emit two or more types of colored rays of light in response to driving currents, and illuminate a predetermined region of the circumferential surface of the reel by using the colored rays;
a lighting driver unit configured to provide the lighting unit with the driving currents according to a control signal received from the exterior thereof, and
a color check unit configured to monitor the levels of the driving currents, and generate an error signal when detecting that one of the levels falls outside a predetermined range;
a game control unit configured to conduct a game by using an arrangement of the symbols displayed on a visible region of the circumferential surfaces of the reels;
a reel control unit configured to command each motor to spin each reel and stop each reel at a predetermined position under control of the game control unit; and
a lighting control unit configured to provide the lighting driver unit with the control signal under control of the game control unit, and if receiving the error signal from the color check unit, inform the game control unit of an error in the lighting unit.
